(19) United States
(12) Patent Application Publication
(10) Pub. No.: US 2008/0035392 A1
(43) Pub. Date: Feb. 14, 2008

(54) WEIGHING DISH FOR ICING AND WEIGHING APPARATUS USING WEIGHING DISH FOR ICING

(75) Inventor: Sadao Nakamura, Colorado Springs, CO (US)

Correspondence Address: SENNIGER POWERS, ONE METROPOLITAN SQUARE, 16TH FLOOR, ST LOUIS, MO, 63102, US

(73) Assignee: YAMATO SCALE CO., LTD., Hyogo (JP)

(21) Appl. No.: 11/608,520

(22) Filed: Dec. 8, 2006

(30) Foreign Application Priority Data
Aug. 10, 2006 (JP) 2006-218351

(51) Int. Cl. G01G 3/08; G01G 23/00; A47J 37/12; B05C 13/00

(52) U.S. Cl. 177/245; 177/229; 99/325; 118/500

(57) ABSTRACT

A weighing dish for icing for use in a weighing apparatus including a load cell for weighing, a vertically extending frame having a lower end connected to the load cell, and a horizontally extending base provided at an upper end of the frame and for mounting the weighing dish on an upper side of the base, is provided including: a top turntable for placing a to-be-weighed subject thereon; and a rotational support member joined to a lower side of the top turntable and supporting the top turntable at plural points for rotation.

### BACKGROUND OF THE INVENTION

1. Field of the Invention

The present invention relates to a weighing dish for icing for use in a weighing apparatus, and a weighing apparatus using the same.

2. Description of the Related Art

Generally, a weighing apparatus having a weighing dish for placing a to-be-weighed subject thereon has a structure in which a frame supporting the weighing dish is linked to a weighing mechanism.

Japanese Patent Laid-Open Publication No. 2006-46912 discloses a structure for mounting a removable weighing dish on a weighing mechanism.

Also, U.S. Pat. No. 5,547,507 discloses a weighing apparatus capable of weighing a cake while the cake is being subjected to icing, which is a cake decorating operation.

### SUMMARY OF THE INVENTION

As shown in FIGS. 1 and 2 of U.S. Pat. No. 5,547,507, the weighing apparatus of this patent has a platen (weighing dish) supported on a vertically extending shaft by means of a flange. The shaft is inserted into a weighing apparatus housing and supported rotatably about its axis. Accordingly, the platen is rotatable at the upper end of the shaft. The lower end of the shaft is vertically displaceably supported by means of a cantilevered beam or a spring, while a rectilinear potentiometer senses a vertical displacement of the lower end of the shaft.

With such a structure, however, weighing variations occur with rotation of the platen because when a moment is exerted on the shaft by some position of the center of gravity of the to-be-weighed subject on the platen, the moment causes variations to occur in the displacement of the cantilevered beam. Also, when the shaft contacts either of a base and a recess formed in the base, the load imposed on the cantilevered beam or the spring varies, which results in weighing variations with rotation.

This structure tends to lessen such weighing variations with rotation by increasing the length of the shaft. However, increasing the length of the shaft causes the height of the whole weighing apparatus to increase, thus resulting in the weighing apparatus upsized.

Further, it has been difficult for such a structure to be applied in an existing weighing apparatus.

The present invention has been made to solve the foregoing problems. Accordingly, it is an object of the present invention to provide a weighing dish for icing which is applicable to an existing weighing apparatus, which allows a to-be-weighed subject to be weighed while rotating the to-be-weighed subject, and which can lessen weighing variations. Another object of the present invention is to provide a weighing apparatus which is capable of weighing the to-be-weighed subject while rotating the to-be-weighed subject, which can lessen weighing variations, and which can be made compact.

A weighing dish for icing according to a 1st aspect of the present invention is a weighing dish for icing in a weighing apparatus including a load cell for weighing, a vertically extending frame having a lower end connected to the load cell, and a horizontally extending base provided at an upper end of the frame and for mounting the weighing dish on an upper side of the base, the weighing dish comprising: a top turntable for placing a to-be-weighed subject thereon; and a rotational support member joined to a lower side of the top turntable and supporting the top turntable at plural points for rotation. This construction is applicable to an existing weighing apparatus and capable of weighing the to-be-weighed subject while rotating the to-be-weighed subject and can lessen weighing variations.

In a weighing dish for icing according to a 2nd aspect of the present invention, the rotational support member may have an upper member attached to the lower side of the top turntable, a lower member attached to an upper side of the base, and plural rollers or spherical members sandwiched between the upper member and the lower member. This feature makes it easy to attach the rotational support member to the top turntable and to the base.

A weighing dish for icing according to a 3rd aspect of the present invention may further comprising: preferably provided with a sealing member configured to narrow a space between the base and the top turntable and shape the space into a crooked configuration on a peripheral side of the rotational support member. With this feature, the rotational support member is enclosed with the base, top turntable and sealing member and, hence, impediment to rotation of the weighing dish due to intrusion of foreign substance into the rotational support member can be prevented.

A weighing dish for icing according to a 4th aspect of the present invention may further comprising: a removable top plate on an upper side of the top turntable for placing the to-be-weighed subject thereon. This feature allows the user to select a suitable one of turntable shapes for an intended cake easily.

In a weighing dish for icing according to a 5th aspect of the present invention, the rotational support member may have plural rollers or spherical members arranged annularly between the top turntable and the base, and a rolling member support frame for holding the rollers or spherical members for rolling. This feature makes it possible to simplify the structure of the rotational support member.

A weighing apparatus according to a 6th aspect of the present invention comprising: a frame having a lower portion fixed to a load cell; a horizontally extending base mounted at an upper end of the frame; and a weighing dish for icing as recited in claim 1 which includes a rotational support member having a lower side joined to an upper side of the base. The weighing apparatus thus constructed is capable of weighing a to-be-weighed subject while rotating the to-be-weighed subject and of lessening weighing variations, and can be made compact.

A weighing apparatus according to a 7th aspect of the present invention may further comprising: a rotating mechanism supported by the frame and rotating a top turntable. With this feature, the operator performing icing does not need to rotate the top turntable and, hence, the burden of the icing operation can be further relieved.

In a weighing apparatus according to an 8th aspect of the present invention may include the load cell and the frame plurally, and the base may be supported by the frames at plural points. This feature makes it possible to reduce the height of the weighing apparatus.

The foregoing and other objects, features and advantages of the present invention will become more apparent from the reading of the following detailed description of the invention with reference to the accompanying drawings.

### BRIEF DESCRIPTION OF THE DRAWINGS

FIG. 1 is a view schematically showing a weighing dish for icing and a weighing apparatus using the weighing dish according to a Embodiment 1 of the present invention;

FIG. 2 is a plan view taken on line II-II and viewed from the direction indicated by arrow in FIG. 1.

FIG. 3 is a view schematically showing a weighing dish for icing and a weighing apparatus using the weighing dish according to a Embodiment 2 of the present invention;

FIG. 4 is a view schematically showing a weighing dish for icing and a weighing apparatus using the weighing dish according to a Embodiment 3 of the present invention;

FIG. 5 is a view showing a variation 1 of a sealing member;

FIG. 6 is a view showing a variation 2 of a sealing member;

FIG. 7 is a view schematically showing a weighing dish for icing and a weighing apparatus using the weighing dish according to a Embodiment 4 of the present invention; and

FIG. 8 is a view schematically showing a weighing dish for icing and a weighing apparatus using the weighing dish according to a Embodiment 5 of the present invention.

### DETAILED DESCRIPTION OF THE PREFERRED EMBODIMENTS

Hereinafter, embodiments of the present invention will be described with reference to the attached drawings.

### Embodiment 1

Description will be made of a weighing dish and a weighing apparatus using this weighing dish according to a Embodiment 1 of the present invention.

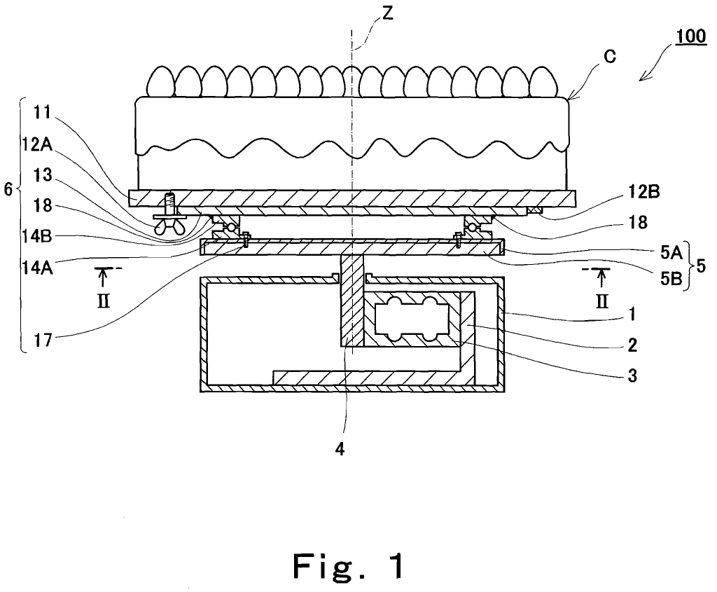

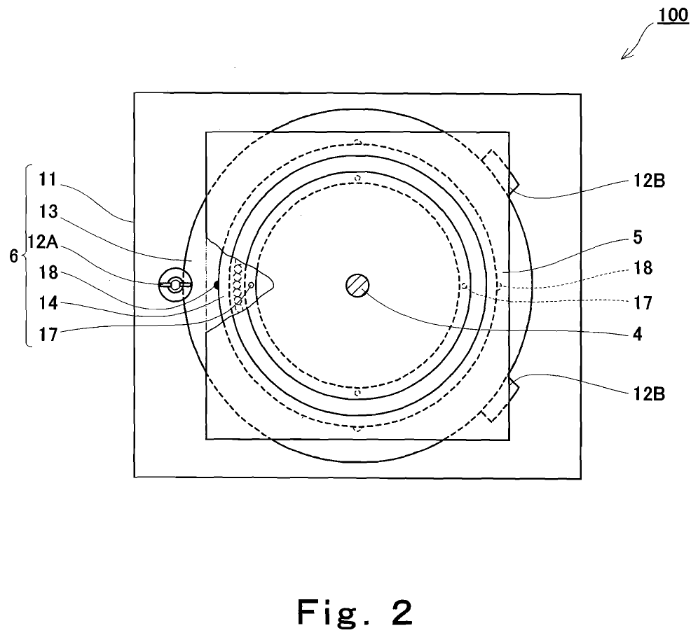

FIG. 1 is a view schematically showing the weighing dish for icing and the weighing apparatus using the weighing dish according to the Embodiment 1 of the present invention. FIG. 2 is a plan view taken on line II-II and viewed from the direction indicated by arrow in FIG. 1. For convenience of description, a base 5 is partially cut away in FIG. 2 to show the structure of weighing dish 6.

Weighing apparatus 100 according to the Embodiment 1 includes a known weighing mechanism provided within a casing 1. Specifically, the weighing mechanism comprises a load cell 3 having one end fixed to a setting member 2 within the casing 1, a columnar frame 4 fixed to the opposite end of the load cell 3 and vertically extending upwardly therefrom, and the base 5 mounted at the upper end of the frame 4 to extend horizontally. With this weighing mechanism, the frame 4 transmits a load imposed on the base 5 from above to the associated end of the load cell 3 to cause the load cell 3 to be strained, and such a strain causes the load cell to sense the load.

The load cell 3 used here is shaped to have two parallel arms linking the frame 4 and the setting member 2 and hence utilizes the Roberval balance mechanism. This means that accurate weighing is possible wherever on the base 5 the center of the load imposed by a cake C is positioned.

The frame 4 preferably has a cylindrical or polygonal shape having a central axis Z vertically extending through the center of the plate surface of the base 5. The frame 4 extends though the upper wall of the casing 1 so as to define a clearance therebetween. This clearance may be covered with a cover comprising such a light and flexible material as not to transmit the load imposed by the frame 4 to the casing 1.

The casing 1 is shaped rectangular-parallelepiped, while the base 5 supported on the frame 4 has a square plane surface covering the upper side of the casing 1. The base 5 comprises a main body 5B having a lower side attached to the frame 4, and a cover 5A covering the upper side of the main body 5B, the main body 5B and the cover 5A being separate members. A rotational support member 14 is mounted on the upper side of the cover 5A. The cover 5A is fitted over the main body 5B with their respective peripheral edges engaging each other. The cover 5A is formed from stainless steel, synthetic resin or the like.

The base 5 may comprise only the main body 5B, with the cover 5A eliminated.

The weighing dish 6 for icing, which is characteristic of the present invention, is mounted on the upper side of the base 5. The weighing dish 6 for icing comprises a top plate 11 for placing the cake C thereon, a circular top turntable 13 having an upper side on which the top plate 11 is mounted thereon, the rotational support member 14 joined to the lower side of the top turntable 13 for supporting the top turntable 13 at plural points for rotation about the predetermined central axis (center of rotation) Z. If the cake C is circular, it is possible to place the cake C directly on the top turntable 13 without using the top plate 11.

The rotational support member 14 comprises an annular thrust bearing supporting the top turntable 13 at plural points. Such a thrust bearing is preferably a bearing of the so-called Lazy Susan type for example. In general, the thrust bearing comprises an upper member 14B and a lower member 14A, which are joined to each other for relative rotation as shown.

In joining the rotational support member 14 to the top turntable 13 and to the base 5, use is made of known joining means such as spot welding, screwing or adhesive. In this embodiment, the upper member 14B forming the upper side of the rotational support member 14 is joined to the top turntable 13 at plural points by spot welding 18. The lower member 14A forming the lower side of the rotational support member 14 is joined to the base 5 by means of plural screws. Thus, the rotational support member 14 supports the top turntable 13 in parallel with and horizontally above the base 5 for rotation about the central axis Z.

The top plate 11 is removably mounted on the upper side of the top turntable 13. In this embodiment, the top plate 11 is mounted on the upper side of the top turntable 13 by means of a mounting mechanism 12 provided on the lower side of the top plate 11. The mounting mechanism 12 comprises a pair of engagement members 12B formed on the lower side of the top plate 11 to engage a peripheral side surface of the top turntable 13, and a clamping screw 12A positioned on the lower side of the top plate 11 so as to catch the top turntable 13 between the clamping screw 12A and the pair of engagement members 12B. The clamping screw 12A is screwed into a threaded hole formed into the lower side of the top plate 11. The top plate 11 is mounted on the upper side of the top turntable 13 in such a manner that the top plate 11 is placed on the upper side of the top turntable 13 so that the pair of engagement members 12B engage the periphery of the top turntable 13 and then the top plate 11 is fastened to the turntable 13 by means of the clamping screw 12A.

The top plate 11 is used to place thereon not a circular cake but a polygonal cake or a circular cake having a larger diameter than the top turntable 13. Therefore, though the plane geometry of the top plate 11 is rectangular in this embodiment, a suitable one of top plate plane geometries, such as a polygonal geometry, is appropriately used for the cake C. Such a removably mounting structure of the top plate 11 makes it possible to select a top plate plane geometry suitable for the cake C easily.

The weighing dish 6 thus constructed according to the present invention can be joined to the base of an existing weighing apparatus and hence is applicable to the existing weighing apparatus. The cake C placed on the top plate 11 is rotatable about the central axis Z serving as the center of rotation. Further, since the frame 4 is supported as fixed to the load cell 3, no variation will occur in the load due to contact with other component of the weighing apparatus 100, and no influence will be exerted on the weighing error by a moment working on the frame 4. Accordingly, the weighing dish 6 for icing according to the present invention allows the to-be-weighed subject to be weighed accurately while rotating the to-be-weighed subject and is capable of lessening weighing variations.

The frame 4 of the weighing apparatus 100 according to the present invention does not need to have a large vertical length and, hence, the casing 1 can be made compact. Accordingly, the weighing apparatus 100 according to the present invention is capable of accurately weighing the to-be-weighed subject while rotating the to-be-weighed subject and of lessening weighing variations, and can be made compact.

Further, since the upper member 14B and lower member 14A of the rotational support member 14 of the present invention can be attached to the circular top turntable 13 and the base 5, respectively, by known joining methods, the rotational support member 14 can be joined to the top turntable 13 and to the base 5 easily.

### Embodiment 2

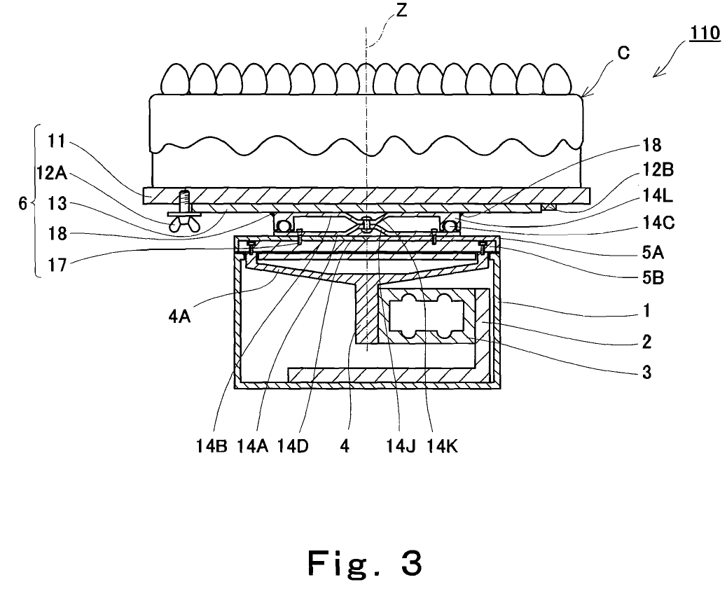

FIG. 3 is a view schematically showing a weighing dish for icing and a weighing apparatus using the weighing dish according to a Embodiment 2 of the present invention.

As shown in FIG. 3, the Embodiment 2 of the present invention is different from the Embodiment 1 in the structures of respective of the base 5, frame 4 and rotational support member 14 and is similar thereto in other components. Therefore, the same reference numerals as those in FIG. 1 denote the same or corresponding parts in FIG. 3, omit description thereof, and only the frame 4 and the rotational support member 14, which are points of difference will be described.

The frame 4 has a lower portion shaped into a columnar or prismatic shaft, and an upper portion shaped into plural branched beams 4A. The plural beams 4A extend radially with an upward inclination. Plural holes are defined through the upper wall of the casing 1, and the beams 4A are inserted through the respective holes and screwed at their respective upper ends to the lower side of the main body 5B of the base 5.

The rotational support member 14 has a lower disk (lower member) 14A and an upper disk (upper member) 14B, which are superposed on each other vertically. The lower disk 14A has a central portion bent upwardly to form a truncated conical protuberance 14J. This protuberance 14J centrally defines a through-hole. The upper disk 14B has a central portion bent downwardly to form an inverted truncated conical recess 14K. This recess 14K centrally defines a through-hole. A pin 14D is inserted through the through-holes of respective of the protuberance 14J and the recess 14K. The pin 14D has opposite ends (upper and lower ends) formed with respective head portions, between which the protuberance 14J and the recess 14K are caught rotatably. Thus, the lower disk 14A and the upper disk 14B are coupled to each other for rotation about the pin 14D by sliding relative to each other.

The lower disk 14A has a lower side joined to the upper side of the base 5 and fixed thereto by means of fastening screws 17 so that the central axis of the pin 14D is coaxial with the central axis Z of the frame 4. The upper disk 14B has an upper side joined to the lower side of the top turntable 13 and fixed thereto so that the central axis of the pin 14D is coaxial with the central axis of the top turntable 13. The upper disk 14B is fixed to the lower side of the top turntable 13 by a spot-welded portion 18 along the peripheral edge of the upper disk 14B.

The lower side of the upper disk 14B is formed with an annular ball receiving portion 14L protruding downwardly and extending along the peripheral edge thereof. The ball receiving portion 14L defines a downwardly open annular groove receiving therein a train of plural balls 14C continued. The balls 14C are in contact with the internal surface of the ball receiving portion 14L and with the upper side of the lower disk 14A and rotate within the ball receiving portion 14L when the upper disk 14B rotates about the pin 14D. This arrangement makes it possible to distribute the load imposed on the upper disk 14B to the pin 14D and to the balls 14C in a decentralizing manner before transmitting the load to the lower disk 14A.

Thus, the rotational support member 14 supports the top turntable 13 on the base 5 for rotation about the central axis Z of the frame 4 while transmitting the load from the top turntable 13 to the base 5 via the pin 14D and the ball receiving portion 14L. The arrangement of the present embodiment can exercise the same effect as does the Embodiment 1.

### Embodiment 3

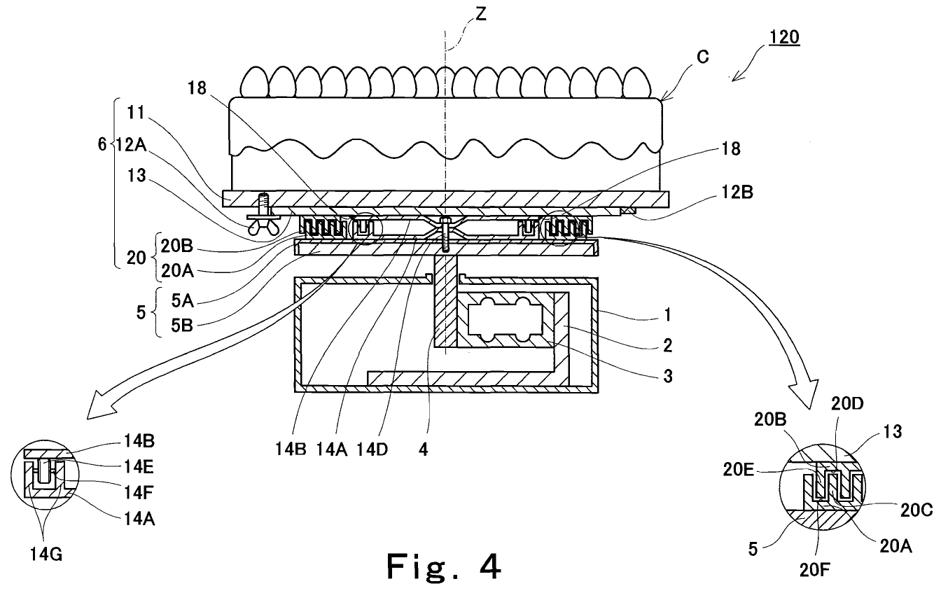

FIG. 4 is a view schematically showing a weighing dish for icing and a weighing apparatus using the weighing dish according to a Embodiment 3 of the present invention.

As shown in FIG. 4, the Embodiment 3 of the present invention is different from the Embodiment 1 in the structure of the rotational support member 14 and the additional provision of a sealing member 20 and is similar thereto in other components. Therefore, the same reference numerals as those in FIG. 1 denote the same or corresponding parts in FIG. 4, omit description thereof, and only the rotational support member 14 and the sealing member 20, which are points of difference will be described.

The rotational support member 14 has the upper disk 14B and lower disk 14A as same as those in FIG. 3, which are joined to each other by means of the pin 14D for rotation about the central axis Z. The pin 14D used here extends vertically downwardly and is joined to the base 5. That is, the rotational support member 14 is joined to the base 5 by means of the pin 14D and, hence, the screws 17 are eliminated.

The lower disk 14A has a peripheral edge portion provided with equidistantly spaced rollers 14E at several points for rotating the lower and upper disks 14A and 14B circumferentially. Like a wheel, each of the rollers 14E is supported on a pin 14F, which in turn is supported on a pin support portion 14G so as to extend radially and horizontally, the pin support portion 14G protruding from the peripheral edge portion of the lower disk 14A. The rollers 14E thus arranged contact the lower and upper disks 14A and 14B to support the upper disk 14B for rotation.

The sealing member 20 is configured to narrow a space between the base 5 and the top turntable 13, and shape the space into a crooked configuration on the outer peripheral side of the rotational support member 14. Specifically, the sealing member 20 comprises an annular upper member 20B protruding from the upper side of the base 5, and an annular lower member 20A protruding from a peripheral edge region of the lower side of the top turntable 13, the upper and lower members 20B and 20A being positioned close to each other. The lower member 20A has bank portions 20C each positioned in a respective one of groove portions 20D of the upper member 20B, while the upper member 20B has bank portions 20E each positioned in a respective one of groove portions 20F of the lower member 20A. With this arrangement, the rotational support member 14 is enclosed with the base 5, top turntable 13 and sealing member 20 and, hence, it is difficult for extraneous particles or fluid to approach the rotational support member 14. That is, impediment to rotation of the weighing dish 6 due to intrusion of foreign substance into the rotational support member 14 can be prevented.

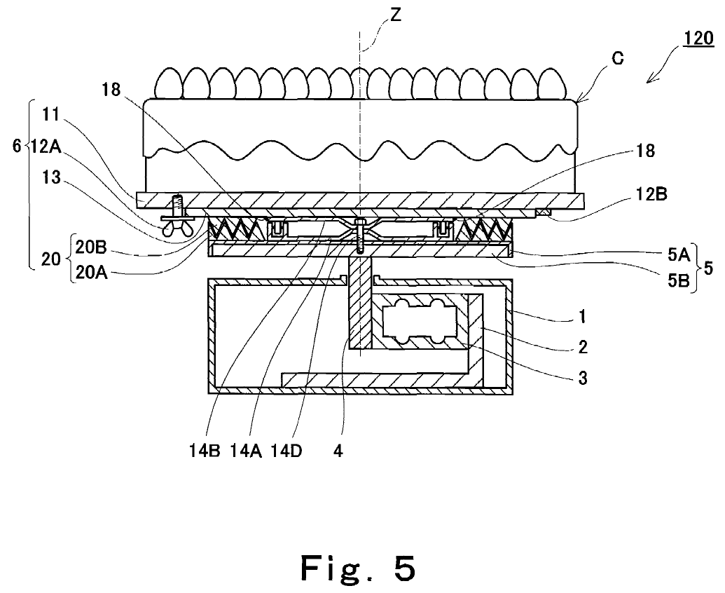

FIG. 5 shows a variation 1 of the sealing member 20.

The sealing member 20 comprises the annular upper member 20B shaped into a serrated configuration in a sectional view, and the annular lower member 20A also shaped into a serrated configuration in a sectional view, the upper and lower members being positioned close to each other to define a narrow space therebetween.

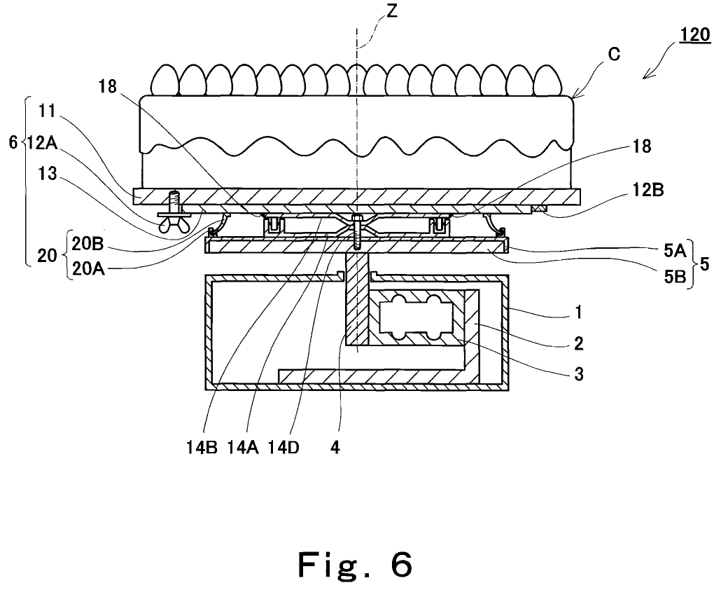

FIG. 6 shows a variation 2 of the sealing member 20.

The sealing member 20 comprises the upper member 20B having an annular extended end extending downwardly, and the lower member 20A having an annular groove receiving the extended end of the upper member 20B.

The upper member 20B is formed from a resin material having flexibility.

### Embodiment 4

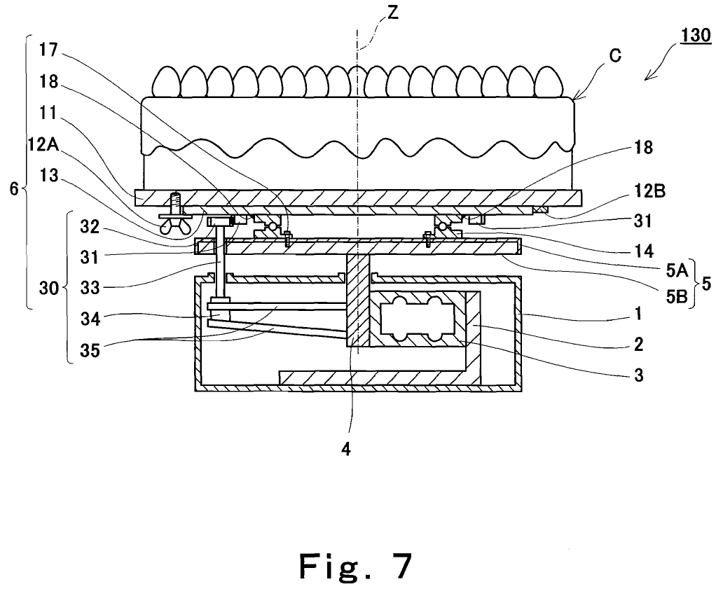

FIG. 7 is a view schematically showing a weighing dish for icing and a weighing apparatus using the weighing dish according to a Embodiment 4 of the present invention.

As shown in FIG. 7, the Embodiment 4 of the present invention is different from the Embodiment 1 in the provision of a rotating mechanism 30 for rotating the top turntable 13 automatically and is similar thereto in other components. Therefore, the same reference numerals as those in FIG. 1 denote the same or corresponding parts in FIG. 7, omit description thereof, and only the rotating mechanism 30, which is point of difference will be described.

The rotating mechanism 30 comprises an annular gear 31 having teeth on the outer periphery thereof and extending on the lower side of the top turntable 13 to encircle the outer periphery of the rotational support member 14, a driving gear 32 meshing with the annular gear 31, a driving shaft 33 extending down into the casing 1, an electric motor 34 for rotating the driving shaft about its axis, and beams 35 supporting the electric motor 34 on the frame 4. Though not shown in FIG. 7, the electric motor 34 is loosely joined with a lead wire having a negligible light weight as compared to the weight of the cake C to be weighed so as not to produce tensile stress. Preferably, the electric motor 34 is a motor that is capable of controlling its rotational speed appropriately.

With this arrangement, the top turntable 13 can be rotated automatically by the rotating mechanism 30 and, hence, the operator performing an icing operation does not need to rotate the top turntable 13 by himself or herself. Thus, the burden of the icing operator can be further relieved.

The structure of the driving shaft 31 may be formed using a pinion, gear and timing belt.

### Embodiment 5

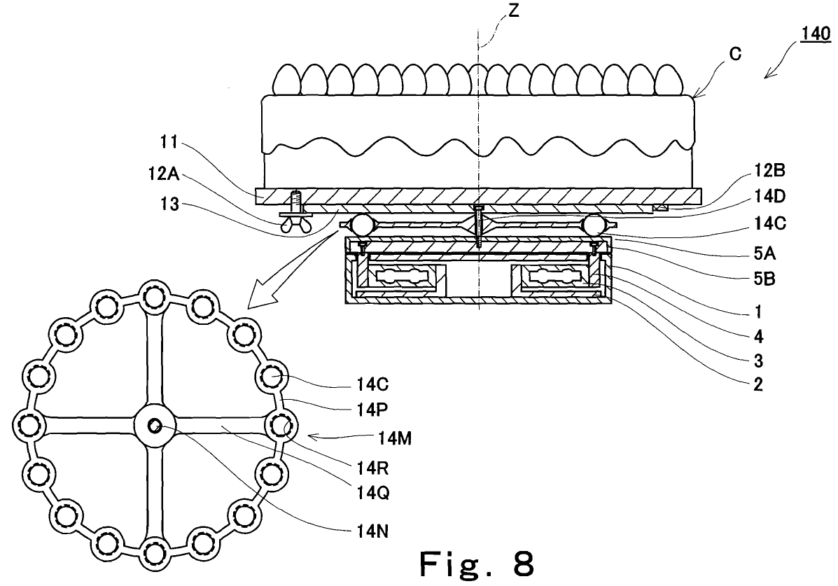

FIG. 8 is a view schematically showing a weighing dish for icing and a weighing apparatus using the weighing dish according to a Embodiment 5 of the present invention.

As shown in FIG. 8, the Embodiment 5 of the present invention is different from the Embodiment 2 in the casing 1, the weighing mechanism within the casing 1, the plane geometry of the base 5 and the structure of the rotational support member 14, and is similar thereto in other components. Therefore, the same reference numerals as those in FIG. 1 and FIG. 3 denote the same or corresponding parts in FIG. 8, omit description thereof, and only the casing 1, the weighing mechanism within the casing 1, the frame 4 and the rotational support member 14, which are points of difference will be described.

The casing 1 of the weighing apparatus 140 according to the present embodiment comprises an upper cover portion and a sidewall portion. That is, the casing 1 forms a cover covering the load cell 3 from above and from side.

The upper cover portion of the casing 1 and the base 5 (including the cover 5A and the main body 5B, which are generally referred to as the base 5) have substantially similar square shapes. The base 5 is overlaid on the upper side of the upper cover portion of the casing 1.

Description will be made of the weighing mechanism within the casing 1. Four frames 4 are mounted under the base 5 so as to extend downwardly from respective four corners of the base 5. Here, a screw is screwed into a threaded hole formed in each frame 4 through the base 5. Only the load cells 3 support the base 5 via the frames 4. Setting members 2 supporting the load cells 3 form a leg portion of the casing 1.

That is, the weighing mechanism within the casing 1 according to the present embodiment includes four sets of load cell 3, frame 4 and setting member 2. The frames 4 are supported by the respective load cells 3, which in turn are supported by the respective setting members 2. The four setting members 2 form the leg portion of the weighing apparatus 140.

This arrangement makes it possible to downsize the casing 1 and the load cells 3, hence, reduce the thickness of the weighing apparatus 140. PB-200 and DSR-400, which are products of Yamato Corporation, are suitable for such casing 1 and weighing mechanism, respectively.

The rotational support member 14 has plural balls 14C arranged annularly, and a rolling member support frame 14M supporting the balls 14C for free rolling. The balls 14C and the rolling member support frame 14M are formed from resin material.

The rolling member support frame 14M is a thin wheel-shaped member having a central hub 14N, a peripheral rim 14P, and spokes 14Q linking the hub and the rim.

The central hub 14N defines a pin receiving hole extending therethrough axially of the wheel.

The peripheral rim 14P is formed with annularly arranged holder frames 14R each embracing a respective one of the balls 14C laterally to hold the ball 14C for free rolling. Each of the holder frames 14R defines a hole having a slightly larger diameter than each ball 14C in which the ball 14C is loosely fitted.

The rolling member support frame 14M is positioned so that the pin receiving hole of the hub 14N coincides with the central axis Z extending through the center of rotation of the circular top turntable 13. A pin 14D extends vertically downwardly from the center of rotation of the top turntable 13 through the pin receiving hole of the hub 14N of the rolling member support frame 14M and is joined to the base 5. Thus, the rolling member support frame 14M, together with the top turntable 13, is joined to the base 5 for rotation about the pin 14D. The balls 14C can be brought into contact with the cover 5A of the base 5 and with the top turntable 13 to support the top turntable 13 for rotational movement. Further, it is possible to reduce the number of elements forming the rotational support member 14, hence, simplify the structure of the rotational support member 14.

The rolling member support frame 14M may be fixed about the pin 14D. In this case, free rolling of the balls 14C enables the top turntable 13 to rotate about the pin 14D.

The rollers 14E used in the Embodiment 3 may be used instead of the balls 14C. In this case, each of the rollers 14E is positioned in a respective one of the holder frames 14R so as to rotate the top turntable 13 circumferentially. If each of the pins 14F shown in FIG. 4 extends radially of the rolling member support frame 14M so as to bridge over peripheral frame edge portions of each holder frame 14R, the rollers 14E can be brought into contact with the top turntable 13 and with the base 5 to support the top turntable 13 for rotation.

Further, each of the ball 14C and the roller 14E preferably has an increased ball diameter or roll diameter. Such a feature makes it possible to suppress up and down surging of the top turntable 13.

It will be apparent from the foregoing description that many improvements and other embodiments of the present invention may occur to those skilled in the art. Therefore, the foregoing description should be construed as an illustration only and is provided for the purpose of teaching the best mode for carrying out the present invention to those skilled in the art. The details of the structure and/or the function of the present invention can be modified substantially without departing from the spirit of the present invention.

For example, it is possible to eliminate the top plate 11. In this case, it is possible to weigh the cake C placed on the top turntable 13 while rotating the cake C.

What is claimed is:

1. A weighing dish for icing for use in a weighing apparatus including a load cell for weighing, a vertically extending frame having a lower end connected to said load cell, and a horizontally extending base provided at an upper end of said frame and for mounting the weighing dish on an upper side of said base, the weighing dish comprising:
a top turntable for placing a to-be-weighed subject thereon; and
a rotational support member joined to a lower side of said top turntable and supporting said top turntable at plural points for rotation.

2. The weighing dish for icing according to claim 1, wherein said rotational support member has an upper member attached to the lower side of said top turntable, a lower member attached to an upper side of said base, and plural rollers or spherical members sandwiched between said upper member and said lower member.

3. The weighing dish for icing according to claim 1 further comprising:
a sealing member configured to narrow a space between said base and said top turntable and shape the space into a crooked configuration on a peripheral side of said rotational support member.

4. The weighing dish for icing according to claim 1 further comprising:
a removable top plate on an upper side of said top turntable for placing the to-be-weighed subject thereon.

5. The weighing dish for icing according to claim 1, wherein said rotational support member has plural rollers or spherical members arranged annularly between said top turntable and said base, and a rolling member support frame for holding said rollers or spherical members for rolling.

6. A weighing apparatus comprising:
a frame having a lower portion fixed to a load cell;
a horizontally extending base mounted at an upper end of said frame; and
a weighing dish for icing as recited in claim 1 which includes a rotational support member having a lower side joined to an upper side of said base.

7. The weighing apparatus according to claim 6 further comprising:
a rotating mechanism supported by said frame and rotating a top turntable.

8. The weighing apparatus according to claim 6 includes said load cell and said frame plurally, and said base is supported by said frames at plural points.

9. A weighing dish for use in a weighing apparatus, said weighing apparatus including a load cell for weighing, a vertically extending frame having a lower end connected to said load cell, and a horizontally extending base at an upper end of said frame for mounting the weighing dish on an upper side of said base, the weighing dish comprising:
a top turntable for placement of product to be weighed, said turntable being rotatable about a vertical axis of rotation;
a rotational support for supporting said top turntable on said base at plural support locations for rotation of the turntable relative to the base about said axis of rotation; and
said plural support locations being spaced radially outward from said axis of rotation.

10. The weighing dish according to claim 9, wherein said support locations are spaced at equal intervals around said axis of rotation for distributing the weight of said product substantially uniformly around said axis of rotation.

11. The weighing dish according to claim 9, wherein said rotational support comprises an upper member attached to a lower side of said top turntable, a lower member for attachment to an upper side of said base, and plural rolling members sandwiched between said upper member and said lower member.

12. The weighing dish according to claim 9, further comprising an annular seal on a lower side of said top turntable surrounding said support locations for sealing the support locations from extraneous particles or fluid.

13. The weighing dish according to claim 9, wherein said rotational support comprises plural rolling members arranged in an annular formation around said axis of rotation on a lower side of the top turntable, and a rolling member support frame for holding said rolling members for rolling.

14. A weighing apparatus comprising:
a load cell;
a frame having a lower portion non-rotatably fixed to the at least one load cell;
a horizontally extending base mounted at an upper end of said frame;
a top turntable for placement of product to be weighed, said turntable being rotatable about a vertical axis of rotation;
a rotational support supporting said top turntable on said base at plural support locations for rotation of the turntable relative to the base about said axis of rotation; and
said plural support locations being spaced radially outward from said axis of rotation.

15. The weighing apparatus according to claim 14, wherein said support locations are spaced at equal intervals around said axis of rotation for distributing the weight of said product substantially uniformly around said axis of rotation.

16. The weighing apparatus according to claim 14, wherein said rotational support comprises an upper member attached to a lower side of said top turntable, a lower member attached to an upper side of said base, and plural rolling members sandwiched between said upper member and said lower member.

17. The weighing apparatus according to claim 14, further comprising an annular seal on a lower side of said top turntable surrounding said support locations for sealing the support locations from extraneous particles or fluid.

18. The weighing apparatus dish according to claim 14, wherein said rotational support comprises plural rolling members arranged in an annular formation around said axis of rotation on a lower side of the top turntable, and a rolling member support frame for holding said rolling members for rolling.

19. The weighing apparatus according to claim 14, further comprising a drive mechanism supported by said frame for rotating said top turntable.

20. The weighing apparatus according to claim 14, wherein said frame has a vertical axis co-incident with said axis of rotation.

21. The weighing apparatus according to claim 14, wherein said base is supported by plural load cells and plural frames.

22. The weighing apparatus according to claim 21, wherein said plural load cells and plural frames are spaced around said axis of rotation.

23. The weighing apparatus according to claim 14, wherein said load cell is a parallelogram load cell.

24. The weighing apparatus according to claim 14, wherein said base is non-rotatably mounted at the upper end of said frame.
